(19) United States
(12) Patent Application Publication
(10) Pub. No.: US 2025/0317354 A1
(43) Pub. Date: Oct. 9, 2025

(54) HARDWARE DISTRIBUTION AND ENERGY EFFICIENT SCHEDULING USING DIGITAL EMISSIONS DATA

(71) Applicant: INTERNATIONAL BUSINESS MACHINES CORPORATION, ARMONK, NY (US)

(72) Inventors: KHAALID PERSAUD JUGGAN MCMILLAN, HAVERSTRAW, NY (US); JOHN S. WERNER, FISHKILL, NY (US); ANDREW C. M. HICKS, HIGHLAND, NY (US); DUSTIN DEMETRIOU, HYDE PARK, NY (US); NATESAN VENKATESWARAN, HOPEWELL JUNCTION, NY (US); JAYAPREETHA NATESAN, HOPEWELL JUNCTION, NY (US); LAKSHMANA-NARASIMHAN EKAMBARAM, OVERLAND PARK, KS (US); ALICE SONG, LAGRANGEVILLE, NY (US); OLUWAFEMI FRANCIS OMOYENI, POUGHKEEPSIE, NY (US)

(21) Appl. No.: 18/626,637

(22) Filed: Apr. 4, 2024

(51) Int. Cl. H04L 41/0833; H04L 41/147

(52) U.S. Cl. CPC H04L 41/0833; H04L 41/147

(57) ABSTRACT

Hardware distribution and energy efficient scheduling using digital emissions data may include determining an emissions load target for an asset, wherein the emissions load target indicates a limit on digital emissions related to operation of the asset; determining, based on energy utilization data, a future energy utilization projection for the asset; generating, based on the future energy utilization projection, a digital emissions forecast for the asset based on digital emissions attributable to the asset; and alleviating an energy demand of a workload executing on the asset in response to determining that the digital emissions forecast exceeds the emissions load target

### BACKGROUND

The present disclosure relates to methods, apparatus, and products for hardware distribution and energy efficient scheduling using digital emissions data. Enterprises are increasingly scrutinizing their carbon footprint and making efforts to improve their environmental impact. As every aspect of a digital presence requires some amount of energy consumption, it is difficult to monitor all of these aspects to ensure that the system as a whole is meeting sustainability goals and targets.

### SUMMARY

According to embodiments of the present disclosure, various methods, apparatus and products for hardware distribution and energy efficient scheduling using digital emissions data are described herein. In some aspects, hardware distribution and energy efficient scheduling using digital emissions data includes determining an emissions load target for an asset, where the emissions load target indicates a limit on digital emissions related to operation of the asset. The method also includes determining, based on energy utilization data, a future energy utilization projection for the asset. The method also includes generating, based on the future energy utilization projection, a digital emissions forecast for the asset based on digital emissions attributable to the asset. The method also includes alleviating an energy demand of a workload executing on the asset in response to determining that the digital emissions forecast exceeds the emissions load target.

### BRIEF DESCRIPTION OF THE DRAWINGS

FIG. 1 sets forth an example computing environment according to aspects of the present disclosure.

FIG. 2 sets forth an example sustainability management environment for hardware distribution and energy efficient scheduling using digital emissions data in accordance with at least one embodiment of the present disclosure.

FIG. 3 sets forth a flow chart of an example method of hardware distribution and energy efficient scheduling using digital emissions data in accordance with at least one embodiment of the present disclosure.

FIG. 4 sets forth a flow chart of another example method of hardware distribution and energy efficient scheduling using digital emissions data in accordance with at least one embodiment of the present disclosure.

FIG. 5 sets forth a flow chart of another example method of hardware distribution and energy efficient scheduling using digital emissions data in accordance with at least one embodiment of the present disclosure.

FIG. 6 sets forth a flow chart of another example method of hardware distribution and energy efficient scheduling using digital emissions data in accordance with at least one embodiment of the present disclosure.

FIG. 7 sets forth a flow chart of another example method of hardware distribution and energy efficient scheduling using digital emissions data in accordance with at least one embodiment of the present disclosure.

### DETAILED DESCRIPTION

Enterprises with a large digital presence are increasingly scrutinizing their carbon footprint and making efforts to improve their environmental impact using data analytics at scale. This can not only include the operation of the data center, but the accounting of hardware and other assets associated with the deployment and retirement of assets. Because data centers are vast, complicated systems that consistently swap in and out assets to maintain the latest technologies, tracking environmental impact to ensure a company meets localized carbon load requirements is an incredibly difficult task. Further, in a typical server-client model, the server is always ‘on’-waiting to respond when a client pings. For many applications there are sometimes long periods when there is no client activity, but the server is still running and consuming energy. A significant amount of energy is consumed even during idle times.

Embodiments according to the present disclosure are directed to hardware distribution and energy efficient scheduling using digital emissions data. In a particular example, lifecycle analysis of the hardware assets deployed in a data center is tied to an energy and emissions analysis of those assets. The energy and emissions associated with manufacturing and utilizing the hardware asset are tracked. Yearly emissions targets are determined for the assets and compared against projected energy utilization of the asset. If the specific hardware asset's utilization forecast shows that it will yield emissions that exceed the yearly emissions target, the energy demand of the asset is alleviated. In some examples, the energy demand is alleviated by moving a workload from the asset to another asset. In some examples, the energy demand is alleviated by setting state schedules for one or more workloads executing on the asset, where the workloads are transitioned to sleep of off states during periods of inactivity in accordance with a schedule.

Embodiments in accordance with the present disclosure are described in the context of digital emissions. The term ‘digital emissions’ refers to the greenhouse gas emissions (e.g., carbon emissions) or other ecologically harmful emissions associated with the operation of a computational hardware asset. For unit standardization, emissions are often converted to a carbon dioxide (CO₂) equivalent, thus digital emissions may simply refer to carbon emissions measured as, e.g., pound or kilogram CO₂e per year. A computational hardware asset, referred to herein as simply an ‘asset,’ may be a computer, server, mainframe, or other computational device operated by an organization. Digital emissions related to the operation of an asset are based, in part, on the power consumed by operation of the asset. Although power utilization contributes to the digital emissions of the asset, digital emissions are distinguished from power utilization as a metric in that the digital emissions metric accounts for other factors such as the type of energy used to power the asset, carbon offsets, carbon credits, etc. For example, an asset that is operated from a solar, wind, or hydroelectric-based power supply will have smaller digital emissions than an asset consuming the same amount of power from a fossil fuel-based power supply. In various accounting methodologies, digital emissions can also encompass the manufacture, distribution, and/or disposal of the asset.

Embodiments in accordance with the present disclosure are described in the context of an emissions load requirement. The emissions load requirement refers to a limit imposed on the amount of digital emissions that are caused by the asset (e.g., a maximum of N lbCO₂e/year). The emissions load requirement can be a lifecycle emissions load requirement that places a limit on the digital emissions attributable to the asset from manufacture and operation of the asset through decommissioning and/or disposal of the asset. The emissions load requirement can be a periodic emissions load requirement that places a limit on the digital emissions attributable to the asset during a given period of time (e.g., a yearly emissions load requirement). In some cases, a yearly emissions load requirement is the lifecycle emissions load requirement divided by the number of years of the anticipated lifecycle. In some cases, the emissions load requirement may be a regulatory requirement that requires digital emissions reporting or carbon footprint reporting to a government agency. For example, a server may be associated with a particular emissions load and digital emissions that exceed this emissions load may be subject to the assessment of a carbon tax. Regulatory agencies may require emissions load reporting for such purposes. In other cases, the emissions load requirement may be self-imposed by an organization in order to meet that organization's sustainability goals.

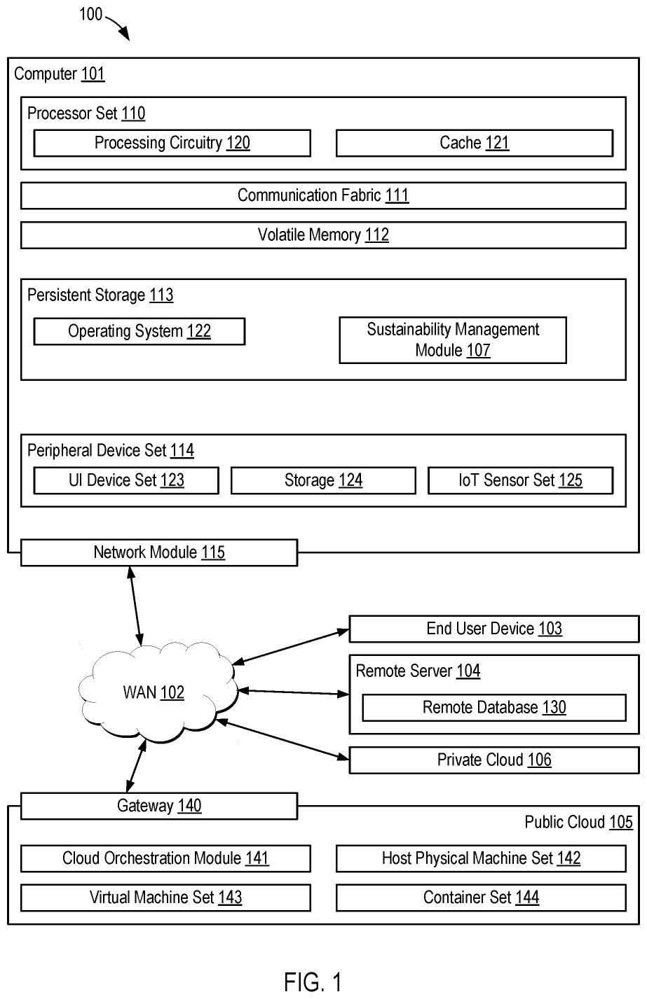

With reference now to FIG. 1, FIG. 1 sets forth an example computing environment according to aspects of the present disclosure. Computing environment 100 contains an example of an environment for the execution of at least some of the computer code involved in performing the various methods described herein, such as sustainability management module 107. In addition to block 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

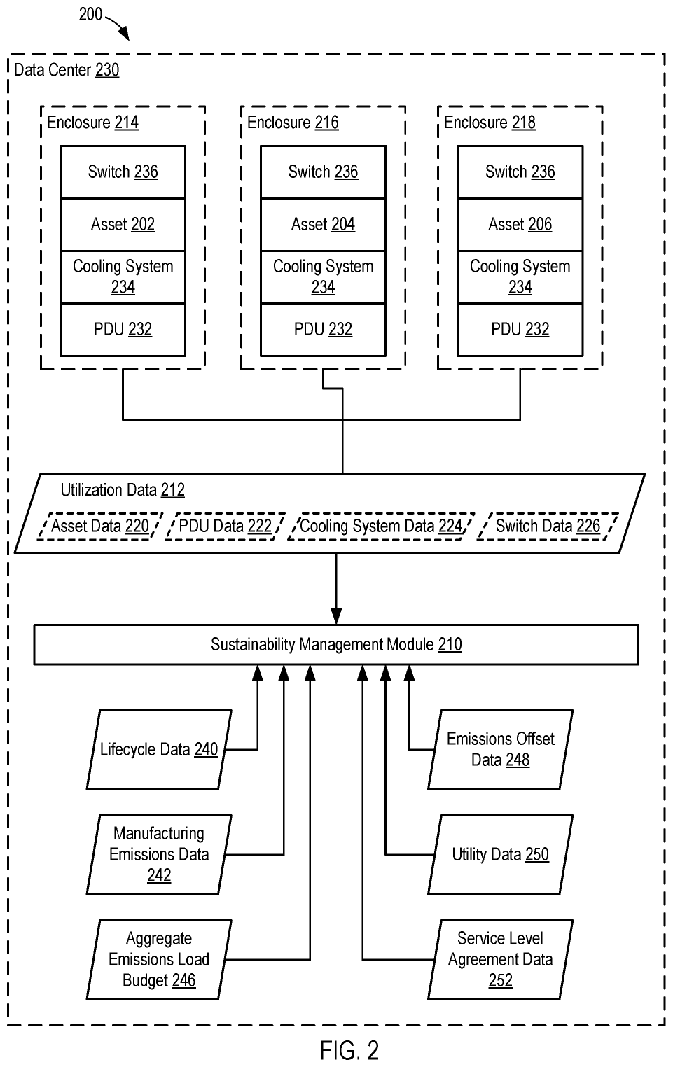

For further explanation, FIG. 2 sets forth a block diagram of an example sustainability management environment 200 for hardware distribution and energy efficient scheduling using digital emissions data in accordance with at least one embodiment of the present disclosure. The example sustainability management environment 200 of FIG. 2 includes a collection of assets 202, 204, 206 that are computational hardware assets configured to execute workloads (e.g., applications, jobs, services, databases, etc.). For example, assets 202, 204 may be servers, mainframes, and so on. Although only three assets are depicted to simplify illustration, it will be appreciated that the sustainability management environment 200 may include any number of assets. In some examples, the assets 202, 204, 206 are managed by a particular organization as part of a data center 230 as depicted in FIG. 2. As such, assets 202, 204, 206 provide computing resources to the organization and/or the organization's customers. Although only one data center is depicted, the sustainability management environment 200 may encompass multiple data centers. For example, the data center may be a hyperscale data center or one of many data centers that support cloud-based compute resources. In some examples, the data center 230 is embodied in a physical data center such as a building in which the assets 202, 204, 206 are housed. Within a physical data center, the sustainability management environment 200 may include other managed assets such as routers, switches, cooling equipment, lighting, and so on. In other examples, the data center 230 is a virtual or cloud-based data center in which assets 202, 204, 206 are distributed across multiple physical data centers.

The assets 202, 204, 206 are managed in part by a sustainability management module 210 (e.g., the sustainability management module 107 of FIG. 1). The sustainability management module 210 analyzes utilization and digital emissions data and adjusts workload placements and/or states based on that data in order to meet sustainability goals or requirements, as will be explained in more detail below. In some implementations, the sustainability management module 210 is integrated into a data center infrastructure management (DCIM) module. In other implementations, the sustainability management module 210 is integrated into a hardware management console (HMC). In still other implementations, the sustainability management module 210 is an independent module that interfaces with other management modules such as a DCIM module or an HMC. In some implementations, the sustainability management module 210 runs on one of the assets 202, 204, 206. In other implementations, the sustainability management module 210 runs on an independent system that may be located within or remote from the data center 230. While in some implementations, the sustainability management module 210 provides workload placement and management to meet the sustainability goals and requirements for the organization that owns the assets 202, 204, 206, in other implementations the sustainability management module 210 is provided as-a-service to the organization's customers such that the customers define parameters to meet their own sustainability goals and requirements. In some examples, the organization may supply raw utilization and emissions data to a customer's sustainability management module 210.

Assets may be provided in enclosure or racks along with other computational and non-computational hardware. In the example of FIG. 2, an enclosure 214 includes at least one asset 202, one or more cooling systems 234, one or more power distribution units (PDUs) 232, and one or more network switches 236 or routers. Assets 204, 206 may be provided in similar enclosures 216, 218, although it will be appreciated that any of the assets 202, 204, 206 may be provided in the same enclosure or in different enclosures. The sustainability management module 210 receives utilization data 212 related to the assets 202, 204, 206 from a variety of sources in the sustainability management environment. In some examples, the utilization data 212 includes asset data 220 from the asset themselves. For example, the asset data 220 may include per-workload utilization metrics for each workload executing on the asset such as CPU utilization, memory utilization, and so on. Where the asset is configured to monitor its own energy draw, such as by a power management module, the asset data 220 may also include the power consumed by the asset. In some examples, the utilization data 212 includes power distribution unit data 222. For example, a power distribution unit 232 coupled to the asset can report the power consumption for that asset. In some examples, the utilization data 212 includes cooling system data 224. For example, a cooling system 234 proximate to the asset in a rack enclosure can report fan speeds and may report its own energy draw using a power management circuit. In some examples, the utilization data 212 includes switch data 226. For example, a network switch 236 coupled to the asset can report its resource utilization and may report its own energy draw using a power management circuit. It will be appreciated that the types of utilization data described above is not an exhaustive list. The utilization data 212 collected or received from various devices in the data center is analyzed to determine the energy demand of the workload and estimate the emissions cost for executing a workload on a particular asset.

In some examples, the sustainability management module 210 collects lifecycle data 240 for each asset 202, 204, 206. The lifecycle data 240 includes an indication of the anticipated lifespan of the asset. For example, the lifecycle data 240 may specify that a server will be operated for 5 years before replacement. The lifecycle data 240 can be reflected in a hardware lifecycle management policy available to the sustainability management module 210 or may be provided to the sustainability management module 210 by a lifecycle management module or a technician or user. In some examples, the lifecycle data 240 is stored in a database.

In some examples, the sustainability management module 210 collects manufacturing emissions data 242 for each asset 202, 204, 206. The manufacturing emissions data 242 indicates the emissions load associated with the manufacture of the asset. For example, the manufacture of the asset may have resulted in X lbCO₂e of greenhouse gases. In some implementations, the manufacturing emissions data 242 is included in the vital product data (VPD) that is encoded in the asset. For example, the sustainability management module 210 may read VPD from firmware or non-volatile memory programmed by the manufacturer to determine the manufacturing emissions related to the asset. In other implementations, the sustainability management module 210 extracts the manufacturing emissions data 242 for the asset from a database or other external data source. In some examples, the manufacturing emissions data 242 is stored in a database.

In some examples, the sustainability management module 210 collects emissions load profiles for each asset 202, 204, 206. The emissions load rating indicates the expected, anticipated, or allowed amount digital emissions generated by operation of the asset under predefined conditions, based on historical profiling, and/or based on emissions data related to similarly configured assets.

In some examples, the sustainability management module 210 collects an aggregate emissions load budget 246. The aggregate emissions load budget 246 indicates a target emission load for a data center, a cluster of assets, or a sustainability environment. For example, the aggregate emissions load budget 246 for a data center represents the targeted total emissions load of the data center based on power consumed by the data center as offset by any emissions credits. In some examples, the aggregate emissions load budget 246 is set by the organization based on sustainability goals or emissions taxes paid for the operation of the data center. This information can be useful in determining specific emissions load target for individual assets. In some examples, the aggregate emissions load budget 246 is stored in a database.

In some examples, the sustainability management module 210 uses the lifecycle data 240, the manufacturing emissions data 242, and/or the aggregate emissions load budget 246 to set an emissions load target for each asset 202, 204, 206 in the sustainability management environment 200. The emissions load target is a periodic target (e.g., yearly, monthly, quarterly) specific to the asset and represents a target maximum digital emissions that are attributable to the asset. For example, each asset 202, 204, 206 is allocated a portion of the aggregate emissions load budget of the data center. In some examples, the emissions load target is calculated to incorporate the manufacturing emissions pro-rated over the lifespan of the asset. However, in some sustainability accounting methodologies, the manufacturing emissions may not be used. In other sustainability accounting methodologies asset transportation and/or asset disposal may be included. It will be appreciated that the yearly emissions load target for an asset 202, 204, 206 may incorporate additional or fewer factors than set forth above.

In some examples, the sustainability management module 210 collects emissions offset data 248. The emissions offset data 248 indicates any emissions credits or emissions offsets that can be applied by the organization to assets or the data center as a whole. The emissions offset data 248 may be specific to a particular jurisdiction such as a state or country in which the data center or asset is located. For example, an organization may receive an emission offset for planting trees in Texas, but the offset cannot be applied to an asset or data center located in California. This information can be useful to the sustainability management module 210 in determining whether to move a workload to an asset in a data center in a different jurisdiction. In some examples, the emissions offset data 248 is stored in a database.

In some examples, the sustainability management module 210 collects utility data 250 indicative of the type of power provided by the utility company. For example, the utility data 250 can include the methods of energy generation (e.g., coal, natural gas, solar, wind, hydroelectric, nuclear) used to supply power to the grid and the percentage of each type. In an illustrative example, the power supplied by the utility company might include 50% coal-generated power, 25% hydroelectric power, and 25% wind-generated power. In some implementations, the utility data 250 is provided by the utility company and programmed into the sustainability management module 210 by a technician or user. The types of power indicated in the utility data are used to calculate digital emissions. Based on the utility data 250, the sustainability management module 210 identifies the energy production emissions associated with the power that is supplied to the assets 202, 204, 206 in the sustainability management environment 200. In some examples, the utility data 250 is stored in a database.

In some examples, the sustainability management module 210 collects service level agreement data 252. The service level agreement data 252 indicates service level requirements a customer or organization for a particular workload or computational resource as part of a service level agreement. For example, a service level requirement may specify an availability of the workload or computational resource (e.g., 99.9% available) or the responsiveness of the workload or computational resource (e.g., 25 millisecond response time). In some examples, the service level agreement specifies a sustainability requirement, such as a yearly emissions load target. In some examples, the service level agreement specifies a jurisdiction(s) to which the workload must be confined. For example, an organization such as a bank may require that a workload operating on its customer's data be confined to a particular country in compliance with the general data protection regulation (GDPR) of the European Union. Thus, a workload executing on one asset can only be moved to another asset within the same jurisdiction.

Using the utilization data described above and the emissions load target, the sustainability management module 210 forecasts whether digital emissions associated with the asset 202, 204, 206 will exceed the emissions load target over some future time period. For the purpose of explanation and not limitation, it will be assumed that the emissions load target is a target for a calendar year. As such, the digital emissions forecast may be a forecast for the time period that is the remainder of the calendar year, in order to determine whether digital emissions associated with the asset will stay within the yearly target. In some examples, the sustainability management module 210 projects an energy utilization associated with each asset 202, 204, 206 using historical utilization data (e.g., the asset data 220, power distribution unit data 222, cooling system data 224, switch data 226, etc.) that has been recorded in a database. For example, the utilization data can be provided to an autoregressive integrated moving average model that generates a time series forecast for the energy utilization over the future time period. Other techniques for generating a time series energy utilization forecast will be apparent to those of skill in the art. In another example, the utilization data can be applied to a pretrained machine learning model to predict the energy utilization over the future time period, where the machine learning model has been trained on a dataset of utilization data.

Using the energy utilization projections and the energy production emissions associated with the power supplied to the assets 202, 204, 206, the sustainability management module 210 generates a digital emissions forecast by estimating the digital emissions attributable to the operation of each asset in the future time period. For example, given the emissions released by the generation of one kilowatt hour of power and the projected power consumption of an asset, the sustainability management module 210 can estimate the amount digital emission that are associated with the asset. As mentioned above, the digital emissions forecast can also account for the pro-rated manufacturing emissions. It will be appreciated that the energy production emissions will vary over the course of time, where more or less reliance on fossil fuels may be necessary at different points in the year. Accordingly, in some examples, the sustainability management module 210 also generates a forecast of the energy production emissions over the future time period using historical energy production emissions data.

Having generated the digital emissions forecast for each asset 202, 204, 206, the sustainability management module 210 compares the emissions load target to the digital emissions forecast to determine whether an asset is predicted to exceed its emissions load target. If the asset is not predicted to exceed the emissions load target, the sustainability management module 210 continues to monitor and record the utilization data to project energy utilization and updates the digital emissions forecast accordingly. If the asset is predicted to exceed the emissions load target or exceeds it by a preconfigured threshold, the sustainability management module 210 takes action to reduce the utilization of the asset.

In some cases, the sustainability management module 210 reduces the utilization of an asset 202, 204, 206 by transferring a workload executing on one asset 202 to a different asset 204, as will be described in more detail below. In other cases, the sustainability management module 210 reduces the utilization of an asset 202, 204, 206 by setting or modifying a state schedule for a workload executing on an asset such that the workload is transitioned between various states (e.g., on, off, idle, hibernate), as will be described in more detail below. The sustainability management module 210 may determine whether the utilization of the asset can be effectively reduced by transferring the workload to a different asset. If the workload cannot be transferred, for example if another asset cannot accommodate it, then the sustainability management module 210 may instead set or modify a state schedule for the workload to reduce the workload's utilization of the asset. Alternatively, the sustainability management module 210 may first determine whether modifying the workload state schedule will reduce the utilization of the asset. If it cannot, the sustainability management module 210 may instead transfer the workload to a different asset. The sustainability management module 210 may determine whether to transfer the workload or modify the state schedule of the workload to reduce utilization based on requirements in a service level agreement. For example, the requirements of the service level agreement may not permit the workload state schedule to be modified (e.g., by necessitating an ‘always on’ state). As another example, the requirements of the service level agreement may not permit the workload to be transferred to another asset if that asset is located in a different jurisdiction. The conditions for determining whether to transfer the workload or alter the workloads state schedule to reduce utilization of the asset may also be based on factors such as the criticality of the workload, availability requirements, a priority level associated with the workload, and so on.

In some examples, to transfer a workload from a first asset 202 to a second asset 204 to reduce digital emissions of the first asset and meet an emissions load target, the sustainability management module 210 identifies the digital emissions forecast of other candidate assets 204, 206. In some implementations, the sustainability management module 210 models the placement of the workload on each candidate asset 204, 206. Based on the modeling, the sustainability management module 210 determines whether the workload can be transferred to either asset. For example, the sustainability management module 210 may determine based on modeling that transferring the workload to a third asset 206 results in a digital emissions forecast for the third asset that indicates the asset will exceeds its emissions load target. The sustainability management module 210 may determine based on modeling that transferring the workload to the second asset 204 results in a digital emissions forecast for the second asset that indicates the asset will not exceed its emissions load target if it takes on the workload. In such a scenario, the sustainability management module 210 determines to transfer the workload from the first asset 202 to the second asset 204.

In some examples, to set or modify a state schedule for a workload executing on an asset, the sustainability management module 210 determines a state schedule for a workload based on an activity profile of the workload and a cost function for a plurality of execution states. For example, the execution states for the cost function can include an ‘active’ state where the workload is executing an actively responding to requests or queries, an ‘on’ state where the workload is executing and ready to respond to requests or queries, an ‘idle’ state where the workload is executing in a sleep state such that responding to a request would have an associated wake-up time, and an ‘off’ state in which execution of the workload has halted altogether. Based on the activity profile and the cost functions, the sustainability management module 210 determines or updates a state schedule for workload states that minimizes the energy consumption of the workload while still meeting service requirements, e.g., as outline in a service level agreement.

In some implementations, the sustainability management module 210 generates a profile of a workload by monitoring its activity based on user requests or queries directed to the workload over a period of time to identify patterns of inactivity. For example, the activity profile may include the number of requests per hour that are received by the workload over the course of a day, week, etc. In another example, the activity profile may include a histogram of the requests received by the workload over the course of a day, week, etc. In some examples, the activity profile for the workload over the period of time can be averaged with other activity profiles for the workload over similar periods of time. For example, the activity profiles for each week in the past four weeks can be averaged together to generate the activity profile for the workload. Based on the activity profile, the sustainability management module 210 determines periods of inactivity. In some implementations, a period of inactivity is defined as meeting a configurable threshold duration of time. For example, to be recognized as a period of inactivity, the duration of inactivity must be a particular number of minutes or hours (e.g., one hour). In one illustrative example, periods of inactivity are expressed in a number of hours, with a minimum duration of inactivity being one hour. In some implementations, a period of inactivity may be associated with a degree of inactivity. For example, a workload might be considered completely inactive only if it receives zero requests in a particular measurement interval (e.g., one hour), but might be considered partially inactive if the workload receives 1 to N number or requests in the measurement interval. In such instances, the sustainability management module 210 may use the degree of inactivity to identify periods of relative inactivity. In some examples, the sustainability management module 210 computes a probability, based on historical data, that a workload would receive a request or query during a period of inactivity.

In some implementations, the sustainability management module 210 generates a cost function for the different workload states based on a set of cost metrics. In some examples, a resource cost metric indicates the cost in asset resources (e.g., CPU load, memory, etc.) for each execution state (e.g., the active, on, idle, and off states described above). For example, an ‘on’ execution state requires more CPU time and system memory than an ‘idle’ execution state, whereas an ‘off’ execution state consumes no CPU time or system memory. In some examples, a bring-up cost metric indicates the costs (e.g., CPU load, effort, duration of time) to transition the workload from an off, idle, or sleep execution state to an on or active execution state. For example, the amount of time needed to transition a workload from an ‘idle’ execution state to an ‘on’ execution state is shorter than the amount of time needed to transition the workload from an ‘off’ execution to the ‘on’ execution state. In some examples, an energy demand metric indicates an average power consumption by the workload in each execution state. In some implementations, the aforementioned costs are predetermined and provided to the sustainability management module 210 as an execution state specification. In other implementations, particularly where the workload is already configured or scheduled to operate in different execution states, the sustainability management module 210 monitors the resource demands, bring-up effort, and energy demands to identify the costs.

In some implementations, the sustainability management module 210 imposes service level requirements on the cost function. The service level requirements can exclude workload states based on their associated costs. For example, a service level agreement with a customer may specify a minimum response time for their workload, such as a minimum time to response to requests, queries, or API calls. If the transition time to the ‘on’ or ‘active’ state from another state exceeds the minimum response time, then that state cannot be used for periods of inactivity. As one illustrative example, if a service level requirement indicates a minimum response time of 25 milliseconds and the transition from the ‘off’ state to the ‘on’ state is 50 milliseconds, then the ‘off’ state cannot be used for the workload. However, if the transition time from the ‘sleep’ state to the ‘on’ state is 15 milliseconds, then the ‘sleep’ state can be used for the workload.

Based on the activity profile, the cost metrics, and the service level requirements, the sustainability management module 210 determines a workload state schedule for the workload that minimizes energy demands of the workload while meeting the service level requirements. The state schedule indicates the workload state for a particular time of day. For example, the state schedule can indicate, for a particular time of day, whether the workload is executed in an ‘on’ state, ‘sleep’ state, or ‘off’ state. In some implementations, the sustainability management module 210 computes the digital emissions related to each state, based on the energy demand, and determines a workload state schedule for the workload based on an amount of digital emissions reduction needed to meet the emissions load target for the asset executing the workload. The sustainability management module 210 then transitions the workload to the different states in accordance with the state schedule. Alternatively, the sustainability management module 210 provides the state schedule to the asset executing the workload, or a separate workload management module, that transitions the workload to the different states in accordance with the state schedule.

In some implementations, the sustainability management module 210 determines the workload state schedule for the workload by evaluating multiple state configurations for each period of inactivity and computing their respective cost metrics, considering the tradeoffs between different configurations. For example, the sustainability management module 210 can determine the cost of placing the workload in the ‘off’ state for only an hour is too high based on a balancing of the bring-up cost against the savings in the resource and energy demand costs. Instead, the sustainability management module 210 may determine that the ‘sleep’ state provides a minimal cost. Conversely, placing the workload in the ‘off’ state for five hours may result in a savings in resource and energy demand costs that is greater than the bring-up cost. Further, energy demand costs can be translated to digital emissions costs based on the time of day. For example, drawing energy at peak times of day can result in more emissions than drawing energy at non-peak times. In some scenarios, the sustainability management module 210 can determine that bookending period of an ‘off’ state with periods of ‘sleep’ states may reduce transition costs between the states.

In some implementations, the sustainability management module 210 determines the workload state schedule for the workload by providing the cost metrics as input to a trained machine learning model. In some examples, the sustainability management module 210 generates training data for the machine learning model. In such examples, the sustainability management module 210 profiles a workload and computes the costs associated with different states, as discussed above. Using this information, the sustainability management module 210 generates multiple state configurations and computes their respective costs. This data is aggregated over time and, in some cases, for multiple workloads or workload types. The aggregated state configurations and associated costs are provided as training data to train the machine learning model. Alternatively, the trained machine learning model can be pretrained using training data that is generated by some other entity. To determine the state schedule for a workload, the sustainability management module 210 computes the costs for the current workload and applies those costs as input to the pretrained machine learning model. The pretrained machine learning model outputs the state schedule for the current workload, which is used by the sustainability management module 210 to transition the workload between the states.

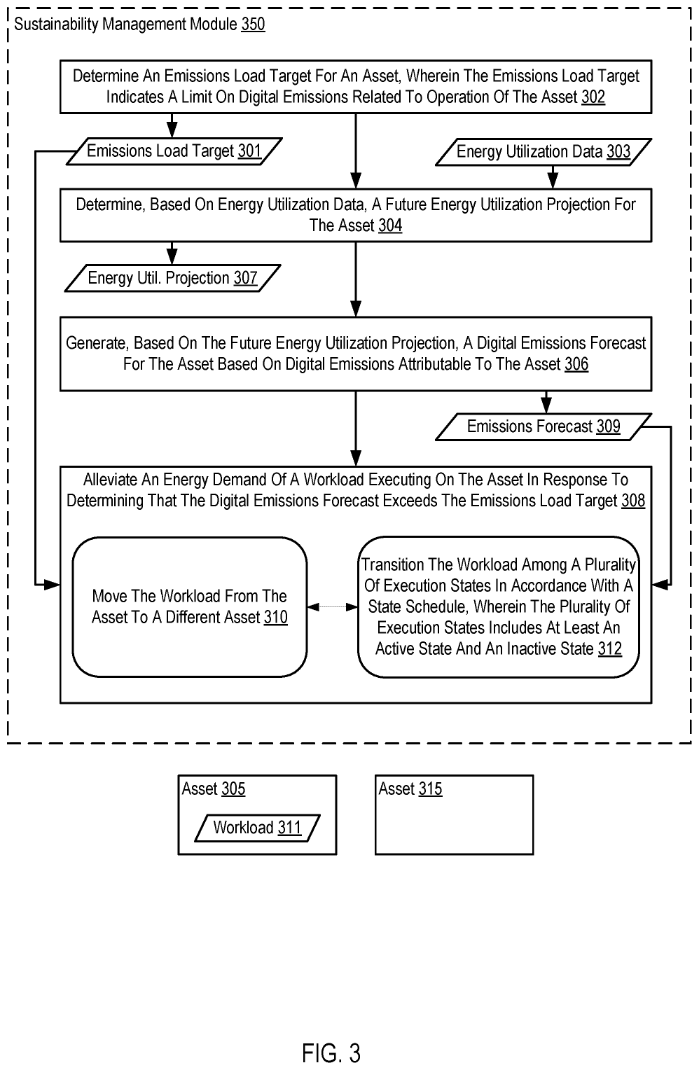

For further explanation, FIG. 3 sets forth a flow chart of an example method for hardware distribution and energy efficient scheduling using digital emissions data in accordance with at least one embodiment of the present disclosure. The example of FIG. 3 includes a sustainability management module 350 (e.g., the sustainability management module 210 of FIG. 2) configured to analyze utilization and digital emissions data and adjust workload placements and/or workload states based on that data in order to meet sustainability goals or requirements. The example of FIG. 3 also includes two or more assets 305, 315 in a sustainability management environment. The assets are computational hardware, such as servers or mainframes, that are configured to execute workloads.

The method of FIG. 3 includes determining 302 an emissions load target 301 for an asset 305, wherein the emissions load target 301 indicates a limit on digital emissions related to operation of the asset 305. The emissions load target 301 is a periodic target (e.g., yearly, monthly, quarterly) specific to the asset and represents a target maximum digital emissions that are attributable to the asset. In some examples, the sustainability management module 350, the emissions load target is specified to the sustainability management module 350. For example, the asset may be budgeted for a particular emissions load that is specified to the sustainability management module 350 via a configuration parameter. In other examples, the sustainability management module 350 determines 302 the emissions load target 301 by computing the emissions load target based on factors such as an apportionment of the overall emissions load target of a data center to the asset and/or the anticipated or observed digital emissions of the asset under a defined set of constraints. For example, the asset may be monitored to identify a particular digital emissions load exhibited when operating at defined utilization and activity levels, or the asset may be rated for a particular emissions load based on benchmark testing. In some implementations, the emissions load target 301 is computed to account for its related manufacturing emissions amortized over the lifespan of the asset. For example, the sustainability management module 350 can read manufacturing emissions from VPD on the asset or identify the manufacturing emissions from a database. The lifespan of the asset can be determined from a lifecycle policy that indicates how long the asset is used before being replaced. However, in other implementations, manufacturing emissions may not be accounted for in the emissions load target, or the emission load target 301 can further account for asset transportation and/or asset disposal. The sustainability management module 350 also determines the emissions load targets for other assets in a sustainability management environment, such as asset 315.

The method of FIG. 3 also includes determining 304, based on energy utilization data 303, a future energy utilization projection 307 for the asset 305. As described above, utilization data is collected by the sustainability management module 350 from various devices in the sustainability management environment and/or data center. For example, the utilization data can be collected from the assets 305, 315, power distribution units, cooling systems, network switches, and so on. In a particular example, energy utilization data 303 related to the operation of the asset can include resource utilization (e.g., CPU and memory) and energy demand data from the asset 305, energy demand data from a power distribution unit coupled to the asset's power supply, energy demand data from a cooling system for the asset 305, and energy demands by other hardware utilized by the asset 305. Based on the current energy utilization data 303, the sustainability management module 350 determines the future energy utilization projection 307 for the asset 305 by, for example, providing the current energy utilization data 303 to an autoregressive integrated moving average model that generates a time series forecast for the energy utilization over a future time period.

The method of FIG. 3 also includes generating 306, based on the future energy utilization projection 307, a digital emissions forecast 309 for the asset 305 based on digital emissions attributable to the asset 305. In some examples, the sustainability management module 350 generates 306 the digital emissions forecast 309 for the asset 305 by calculating digital emissions based on the projected energy demand. In some implementations, the digital emissions are calculated by determining the emissions released by the generation of power that is used to power the data center in which the asset is located. For example, solar, wind, and hydroelectric power are not associated with emissions, whereas coal-based power and natural gas-based power are each associated with different amounts of emissions. Utility companies can provide power that is generated from a mixture of these different types of power. Further, the time of day or time of year may affect the efficiency of the power supplied by utility companies. Still further, organizations may apply credits to offset emissions based on conservation efforts. These different factors influence the net emissions that are associated with powering the asset. The sustainability management module 350 computes, based on such factors, a forecasted amount of digital emissions attributable to asset given the projected energy utilization of the asset over a future time period. For example, given a monitoring period of one year, the sustainability management module 350 can calculate the digital emissions already generated based on historical energy utilization and can determine the digital emissions of the projected energy utilization. Based on these two numbers, the sustainability management module 350 can forecast the accumulated digital emissions attributable over the one-year period.

The method of FIG. 3 also includes alleviating 308 an energy demand of a workload 311 executing on the asset 305 in response to determining that the digital emissions forecast 309 exceeds the emissions load target 301. In some examples, the sustainability management module 350 compares the digital emissions forecast 309 to the emissions load target 301 to determine whether the digital emissions forecast 309 exceeds the emissions load target 301 or exceeds the emissions load target 301 by a threshold amount. When the digital emissions forecast 309 exceeds the emissions load target 301, the sustainability management module 350 alleviates the energy demand of a workload 311 executing on the asset 305 by moving 310 the workload 311 to a different asset 315 or by transitioning 312 the workload 311 among a plurality of execution states in accordance with a state schedule, where the execution states include at least an active state and an inactive state, as will be explained in more detail below. In some cases, the sustainability management module 350 may first determine whether the energy demand of the workload can be alleviated by moving 310 the workload 311. If it cannot, the sustainability management module 350 alleviates the energy demand of the workload 311 by transitioning 312 the workload 311 among a plurality of execution states in accordance with a state schedule. In other cases, the sustainability management module 350 may first determine whether the energy demand of the workload can be alleviated by transitioning 312 the workload among a plurality of execution states in accordance with a state schedule. If it cannot, the sustainability management module 350 alleviates the energy demand of the workload 311 by moving 310 the workload 311 to a different asset 315. The technique is first favored may depend on service level requirements for the workload 311 and the availability of other assets to execute the workload 311. In some implementations the sustainability management module 350 models the reduction in energy demand achieved by each technique to determine the optimal technique for reducing the overall energy demand of the data center. For example, the sustainability management module 350 may determine whether moving 310 the workload 311 to a different asset will reduce the energy demand of the data center more than transitioning 312 the workload 311 among a plurality of execution states in accordance with a state schedule, and vice versa.

In some examples, the sustainability management module 350 transitions 312 the workload 311 among a plurality of execution states in accordance with a state schedule by setting a state schedule for the workload 311 in which the workload executes in different execution states at different times of the day. For example, during periods of low activity, the sustainability management module 350 sets a state schedule to place the workload in an inactive state such as an idle, sleep, hibernate, or off state, at particular times of day. Otherwise, the workload executes in an active or ‘on’ state.

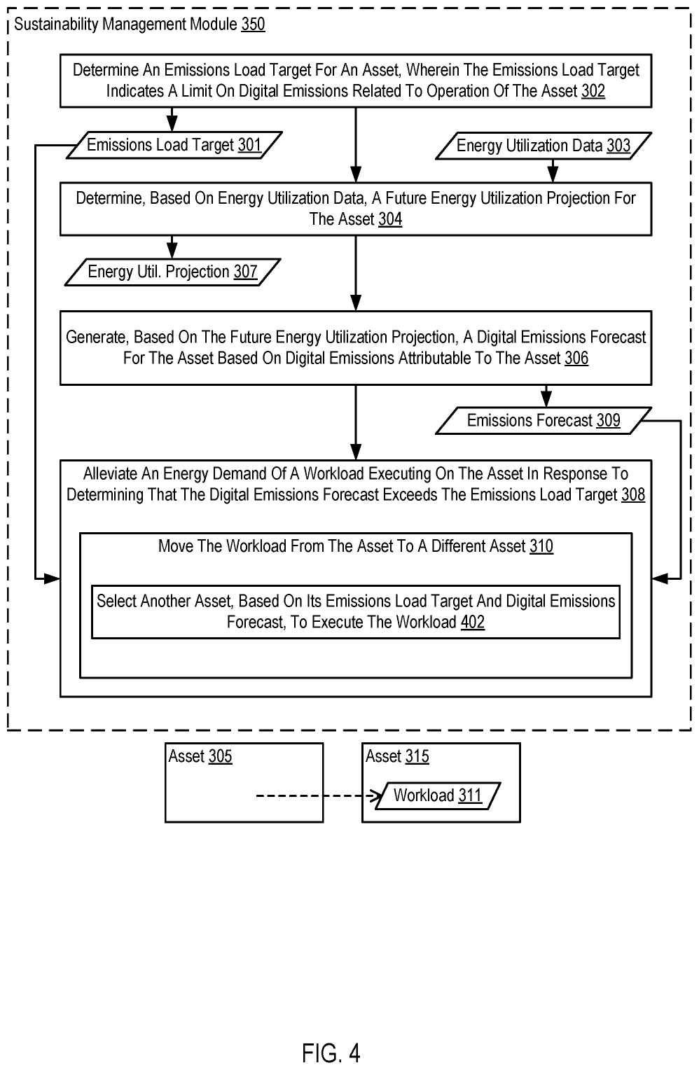

For further explanation, FIG. 4 sets forth a flow chart of another example method of hardware distribution and energy efficient scheduling using digital emissions data in accordance with at least one embodiment of the present disclosure. The method of FIG. 4 extends the method of FIG. 3 in that moving 310 the workload 311 to a different asset 315 includes selecting 402 another asset 315, based on its emissions load target and digital emissions forecast, to execute the workload 311. In some examples, the sustainability management module 350 selecting 402 the asset 315 by identifying the digital emissions forecasts of other candidate assets. In some implementations, the sustainability management module 350 models the placement of the workload on each candidate asset. For example, the sustainability management module 350 may estimate the increase in digital emissions attributable to a second asset 315 if the workload 311 were transferred to the second asset 315. The sustainability management module 350 may determine based on modeling that transferring the workload to a second asset 315 results in a digital emissions forecast for the second asset 315 that does not exceed its emissions load target. In such a scenario, the sustainability management module 350 determines to transfer the workload from the first asset 305 to the second asset 315. In some examples, moving 310 the workload 311 includes halting execution of the workload 311 on the first asset 305 and bringing up the workload 311 on the second asset 315. In other examples, moving 310 the workload 311 includes bringing up the workload on the second asset 315, redirecting network traffic to the second asset 315, and then halting execution of the workload 311 on the first asset 305.

In some examples, the sustainability management module 350 can select an asset that is in a different data center. For example, the sustainability management module 350 may determine that there is no asset that is collocated with the asset 305 executing the workload that can take on the workload 311 without exceeding its own emissions load target. In such a scenario, the sustainability management module 350 may move the workload to an asset in a different data center. In another example, the sustainability management module 350 may determine that moving the asset to a different data center will result in an overall reduction in digital emissions. For example, the other data center could be located in a jurisdiction in which the organization has emissions credits, or may be operating below its digital emissions budget.

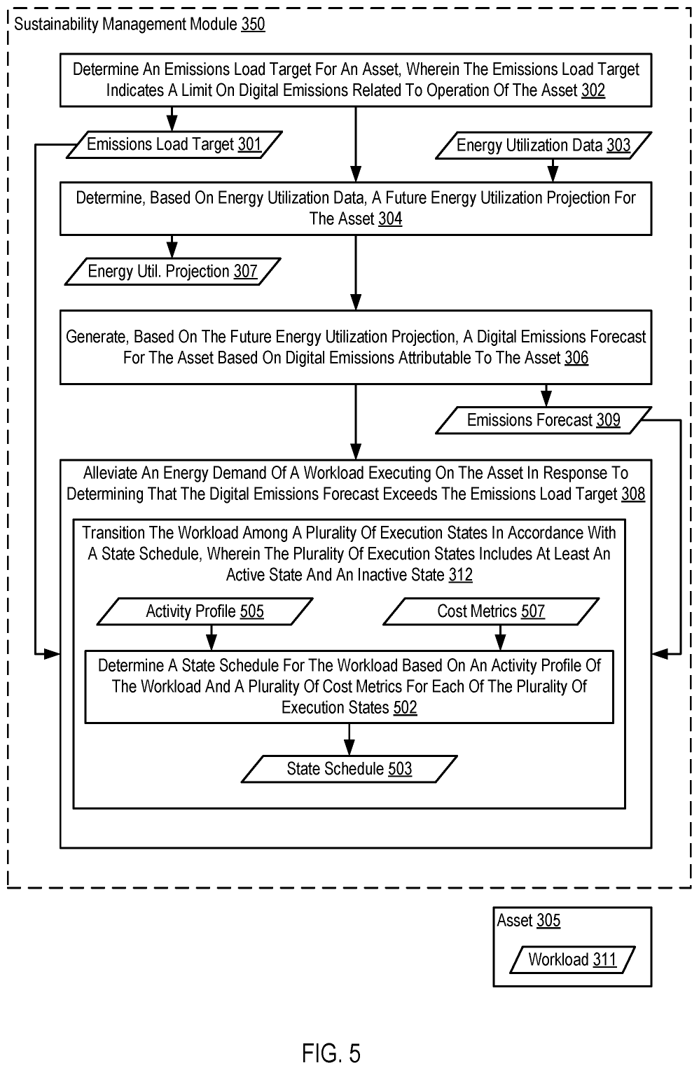

For further explanation, FIG. 5 sets forth a flow chart of another example method of hardware distribution and energy efficient scheduling using digital emissions data in accordance with at least one embodiment of the present disclosure. The method of FIG. 5 extends the method of FIG. 3 in that transitioning 312 the workload 311 among a plurality of execution states in accordance with a state schedule includes determining 502 a state schedule 503 for the workload 311 based on an activity profile 505 of the workload and a plurality of cost metrics 507 for each of the plurality of execution states. In some implementations, as discussed above, the sustainability management module 350 periods of inactivity from an activity profile of the workload. As also discussed above, the sustainability management module 350 determines costs associated with different execution states including active states (e.g., an ‘on’ state) and inactive states (e.g., ‘sleep’ and ‘off’ states). In some examples the costs include a resource cost metric that indicates the cost in asset resources (e.g., CPU load, memory, etc.) for each execution state (e.g., the active, on, idle, and off states described above). In some examples, the costs include a bring-up cost metric that indicates the costs (e.g., CPU load, effort, duration of time) to transition the workload from an ‘off,’ or ‘sleep’ execution state to an ‘on’ or ‘active’ execution state. In some examples, the costs include an energy demand metric that indicates an average power consumption by the workload in each execution state.

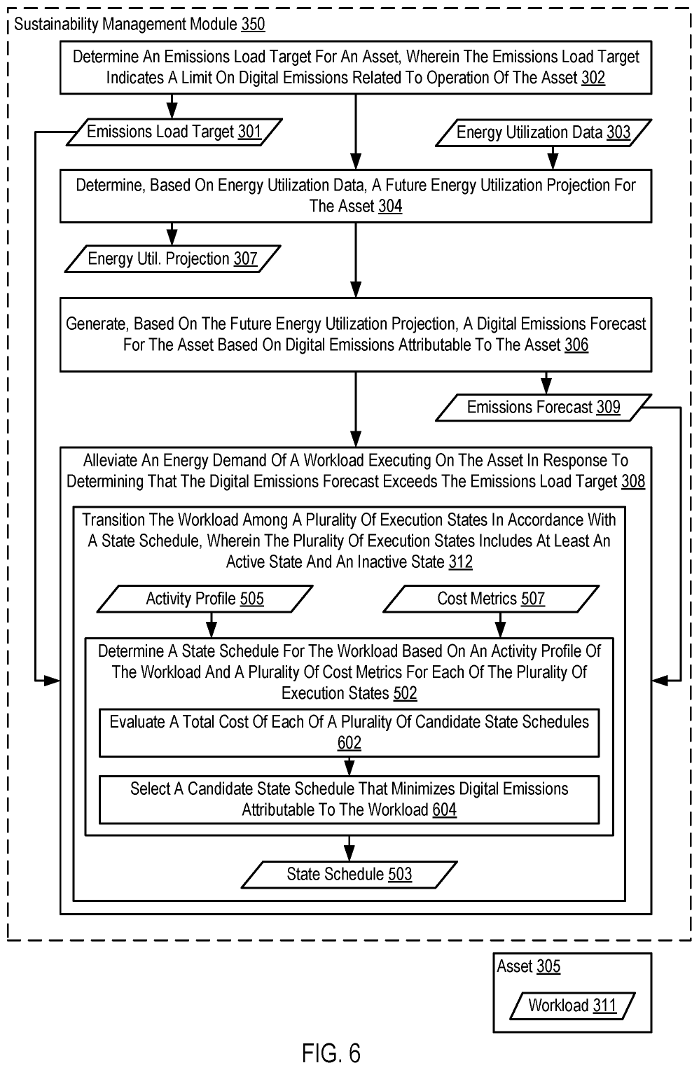

For further explanation, FIG. 6 sets forth a flow chart of another example method of hardware distribution and energy efficient scheduling using digital emissions data in accordance with at least one embodiment of the present disclosure. The method of FIG. 6 extends the method of FIG. 5 in that determining 502 a state schedule 503 for the workload 311 based on an activity profile 505 of the workload and a plurality of cost metrics 507 for each of the plurality of execution states includes evaluating 602 a total cost of each of a plurality of candidate state schedules. In some examples, the sustainability management module 350 evaluates 602 the total cost of the plurality of candidate state schedules by generating multiple candidate state schedules for a given time period (e.g., 24 hours), where the different candidate state schedules include different state configurations. For example, for a particular period of inactivity, the sustainability management module 350 may generate a candidate state schedule that places the workload in an ‘off’ state, while in a different candidate state schedule workload is placed in a ‘sleep’ state. The sustainability management module 350 then evaluates 602 the total of each candidate schedule by computing the total cost of the state schedule over the time period using the cost metrics discussed above.

The method of FIG. 6, determining 502 the state schedule 503 for the workload 311 also includes selecting 604 a candidate state schedule that minimizes digital emissions attributable to the workload 311. In some examples, the sustainability management module 350 selects 604 a candidate state schedule that minimizes digital emissions attributable to the workload 311 by identifying the candidate state schedule that indicates the largest reduction in digital emissions based on the costs computed for the plurality of candidate state schedules. For example, the sustainability management module 350 selects the candidate state schedule that results in the lowest energy demand of the workload. In some examples, the sustainability management module 350 selects the candidate state schedule that results in the lowest energy demand of the workload while also meeting service level requirements. For example, the service level requirements may be indicated by a service level agreement.

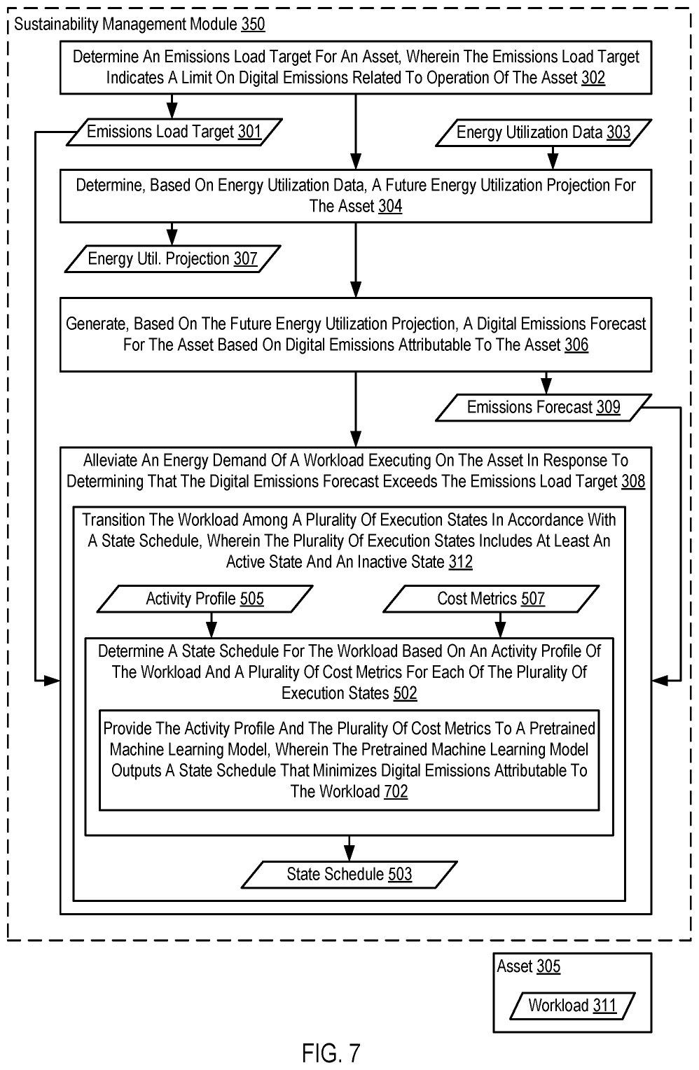

For further explanation, FIG. 7 sets forth a flow chart of another example method of hardware distribution and energy efficient scheduling using digital emissions data in accordance with at least one embodiment of the present disclosure. The method of FIG. 7 extends the method of FIG. 5 in that determining 502 a state schedule 503 for the workload 311 based on an activity profile 505 of the workload and a plurality of cost metrics 507 for each of the plurality of execution states includes providing 702 the activity profile and the plurality of cost metrics to a pretrained machine learning model, wherein the pretrained machine learning model outputs a state schedule that minimizes digital emissions attributable to the workload 311. In some examples, the sustainability management module 210 generates training data for the machine learning model. In such examples, the sustainability management module 210 profiles a workload and computes the costs associated with different states, as discussed above. Using this information, the sustainability management module 210 generates multiple state configurations and computes their respective costs. This data is aggregated over time and, in some cases, for multiple workloads or workload types. The aggregated state configurations and associated costs are provided as training data to train the machine learning model. Alternatively, the trained machine learning model can be pretrained using training data that is generated by some other entity. To determine the state schedule for a workload, the sustainability management module 210 computes the costs for the current workload and applies those costs as input to the pretrained machine learning model. The pretrained machine learning model outputs the state schedule for the current workload, which is used by the sustainability management module 210 to transition the workload between the states.

It will be appreciated in view of the foregoing embodiments in accordance with the present disclosure provide a variety of techniques for hardware distribution and energy efficient scheduling using digital emissions data. In one illustrative scenario, a sustainability management module determines that a digital emissions forecast for an asset will exceed an emissions load target for the asset. In response, the sustainability management module alleviates the energy demand of the asset by moving a workload to a different asset. In another illustrative scenario, a sustainability management module determines that a digital emissions forecast for an asset will exceed an emissions load target for the asset. In response, the sustainability management module alleviates the energy demand of the asset by transitioning the workload among a plurality of execution states in accordance with a state schedule, wherein the plurality of execution states include at least an active state and an inactive state.

In yet another illustrative scenario, a sustainability management module determines that a digital emissions forecast for an asset will exceed an emissions load target for the asset. In response, the sustainability management module first determines whether digital emissions can be reduced by moving the workload. If so, the sustainability management module alleviates the energy demand of the asset by moving a workload to a different asset. If the workload cannot be moved, for example because no other asset can take on the workload without violating its own emissions load target, the sustainability management module alleviates the energy demand of the asset by transitioning the workload among a plurality of execution states in accordance with a state schedule.

In yet another illustrative scenario, a sustainability management module determines that a digital emissions forecast for an asset will exceed an emissions load target for the asset. In response, the sustainability management module first determines whether digital emissions can be reduced by setting a state schedule including a plurality of execution states for the workload. If so, the sustainability management module alleviates the energy demand of the asset by transitioning the workload among a plurality of execution states in accordance with the state schedule. If the state schedule does not reduce digital emissions or would violate service requirements, the sustainability management module alleviates the energy demand of the asset by moving the workload to a different asset.

In yet another illustrative scenario, a sustainability management module determines that a digital emissions forecast for an asset will exceed an emissions load target for the asset. In response, the sustainability management module determines whether moving the workload to a different asset or transitioning the workload among a plurality of execution states in accordance with the state schedule will result in the fewest digital emissions and selects that approach to alleviate the energy demand of the workload on the asset.

An embodiment is directed to a method of hardware distribution and energy efficient scheduling using digital emissions data. The method includes determining an emissions load target for an asset, where the emissions load target indicates a limit on digital emissions related to operation of the asset. The method also includes determining, based on energy utilization data, a future energy utilization projection for the asset. The method also includes generating, based on the future energy utilization projection, a digital emissions forecast for the asset based on digital emissions attributable to the asset. The method also includes alleviating an energy demand of a workload executing on the asset in response to determining that the digital emissions forecast exceeds the emissions load target. In this way, an organization can track the digital emissions of each asset in a data center to ensure that the organization is meeting its sustainability goals and/or regulatory requirements. This technique utilizes an ecological impact analysis rather than simply reallocating workloads based on instantaneous demands. In some examples, the emissions load target accounts for emissions related to manufacture of the asset.

In some implementations, alleviating an energy demand of the workload executing on the asset in response to determining that the digital emissions forecast exceeds the emissions load target includes moving the workload from the asset to a different asset. In such implementations, moving the workload from the asset to the different asset can include selecting another asset, based on its emissions load target and digital emissions forecast, to execute the workload. In this way, workloads are reallocated based on each asset's ability to stay withing an ecological impact budget in order to ensure that the organization is meeting its sustainability goals and/or regulatory requirements. In some examples, moving the workload includes moving the workload to a different datacenter. In this way, a workload can be transferred to a data center that is operating within its own ecological impact budget, or for which there are available carbon offsets or credits. In some examples, moving the workload is responsive to determining that the energy demand of the workload cannot be alleviated by transitioning the workload among a plurality of execution states in accordance with a state schedule. In this way, the energy demand of the workload on an asset can be alleviated by a second technique if the first technique cannot be carried out or if it does not alleviate enough energy demand to bring the asset into compliance with its ecological impact budget.

In some implementations, an energy demand of the workload executing on the asset in response to determining that the digital emissions forecast exceeds the emissions load target includes transitioning the workload among a plurality of execution states in accordance with a state schedule, where the plurality of execution states includes at least an active state and an inactive state. In this way, the energy demand caused by the workload can be alleviated by placing the workload into an inactive state during identified periods of inactivity. In such implementations, transitioning the workload among a plurality of execution states in accordance with a state schedule can include determining a state schedule for the workload based on an activity profile of the workload and a plurality of cost metrics for each of the plurality of execution states. In this way, a state schedule can be selected to minimize the ecological impact of the workload. In such implementations, determining the state schedule for the workload can include evaluating a total cost of each of a plurality of candidate state schedules and selecting a candidate state schedule that minimizes digital emissions attributable to the workload. In other implementations, determining the state schedule for the workload can include providing the activity profile and the plurality of cost metrics to a pretrained machine learning model, wherein the pretrained machine learning model outputs a state schedule that minimizes digital emissions attributable to the workload. In some examples, determining the state schedule for the workload is further based on service level requirements for the workload. In this way, it can be assured that placing the workload into an inactive state will not violate service level agreements. In some examples, determining the state schedule for the workload is responsive to determining that the energy demand of the workload cannot be alleviated by moving the workload. In this way, the energy demand of the workload on an asset can be alleviated by a second technique if the first technique cannot be carried out or if it does not alleviate enough energy demand to bring the asset into compliance with its ecological impact budget.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
determining an emissions load target for an asset, wherein the emissions load target indicates a limit on digital emissions related to operation of the asset;
determining, based on energy utilization data, a future energy utilization projection for the asset;
generating, based on the future energy utilization projection, a digital emissions forecast for the asset based on digital emissions attributable to the asset; and
alleviating an energy demand of a workload executing on the asset in response to determining that the digital emissions forecast exceeds the emissions load target.

2. The method of claim 1, wherein the emissions load target accounts for emissions related to manufacture of the asset.

3. The method of claim 1, wherein alleviating an energy demand of the workload executing on the asset in response to determining that the digital emissions forecast exceeds the emissions load target includes:
moving the workload from the asset to a different asset.

4. The method of claim 3, wherein moving the workload from the asset to the different asset includes:
selecting another asset, based on its emissions load target and digital emissions forecast, to execute the workload.

5. The method of claim 3, wherein moving the workload includes moving the workload to a different datacenter.

6. The method of claim 3, wherein moving the workload is responsive to determining that the energy demand of the workload cannot be alleviated by transitioning the workload among a plurality of execution states in accordance with a state schedule.

7. The method of claim 1, wherein alleviating an energy demand of the workload executing on the asset in response to determining that the digital emissions forecast exceeds the emissions load target includes:
transitioning the workload among a plurality of execution states in accordance with a state schedule, wherein the plurality of execution states includes at least an active state and an inactive state.

8. The method of claim 7, wherein transitioning the workload among a plurality of execution states in accordance with a state schedule includes:
determining a state schedule for the workload based on an activity profile of the workload and a plurality of cost metrics for each of the plurality of execution states.

9. The method of claim 8, wherein determining the state schedule for the workload includes:
evaluating a total cost of each of a plurality of candidate state schedules; and
selecting a candidate state schedule that minimizes digital emissions attributable to the workload.

10. The method of claim 8, wherein determining the state schedule for the workload includes:
providing the activity profile and the plurality of cost metrics to a pretrained machine learning model, wherein the pretrained machine learning model outputs a state schedule that minimizes digital emissions attributable to the workload.

11. The method of claim 8, wherein determining the state schedule for the workload is further based on service level requirements for the workload.

12. The method of claim 7, wherein determining the state schedule for the workload is responsive to determining that the energy demand of the workload cannot be alleviated by moving the workload.

13. An apparatus comprising:
a processing device; and
memory operatively coupled to the processing device, wherein the memory stores computer program instructions that, when executed, cause the processing device to:
determine an emissions load target for an asset, wherein the emissions load target indicates a limit on digital emissions related to operation of the asset;
determine, based on energy utilization data, a future energy utilization projection for the asset;
generate, based on the future energy utilization projection, a digital emissions forecast for the asset based on digital emissions attributable to the asset; and
alleviate an energy demand of a workload executing on the asset in response to determining that the digital emissions forecast exceeds the emissions load target.

14. The apparatus of claim 13, wherein to alleviate an energy demand of a workload executing on the asset in response to determining that the digital emissions forecast exceeds the emissions load target, the memory stores computer program instructions that, when executed, cause the processing device to:
moving the workload from the asset to a different asset.

15. The apparatus of claim 13, wherein to alleviate an energy demand of a workload executing on the asset in response to determining that the digital emissions forecast exceeds the emissions load target, the memory stores computer program instructions that, when executed, cause the processing device to:
transition the workload among a plurality of execution states in accordance with a state schedule, wherein the plurality of execution states includes at least an active state and an inactive state.

16. The apparatus of claim 15, wherein to transition the workload among a plurality of execution states in accordance with a state schedule, the memory stores computer program instructions that, when executed, cause the processing device to:
determining a state schedule for the workload based on an activity profile of the workload and a plurality of cost metrics for each of the plurality of execution states.

17. The apparatus of claim 16, wherein the cost metrics include resource costs, state transition costs, and energy demand costs for each of the plurality of execution states.

18. A computer program product comprising a computer readable storage medium, wherein the computer readable storage medium comprises computer program instructions that, when executed:
determine, based on energy utilization data, a future energy utilization projection for an asset;
generate, based on the future energy utilization projection, a digital emissions forecast for the asset based on digital emissions attributable to the asset; and
alleviate an energy demand of a workload executing on the asset in response to determining that the digital emissions forecast exceeds an emissions load target.

19. The computer program product of claim 18, wherein to alleviate an energy demand of a workload executing on the asset in response to determining that the digital emissions forecast exceeds the emissions load target, the computer readable storage medium comprises computer program instructions that, when executed:
moving the workload from the asset to a different asset.

20. The computer program product of claim 18, wherein to alleviate an energy demand of a workload executing on the asset in response to determining that the digital emissions forecast exceeds the emissions load target, the computer readable storage medium comprises computer program instructions that, when executed:
transition the workload among a plurality of execution states in accordance with a state schedule, wherein the plurality of execution states includes at least an active state and an inactive state.
